(19) United States
(12) Patent Application Publication
(10) Pub. No.: US 2018/0202627 A1
(43) Pub. Date: Jul. 19, 2018

(54) METHOD FOR PRODUCING COLLAPSIBLE STRUCTURES

(71) Applicant: Indiana University Research and Technology Corporation, Indianapolis, IN (US)

(72) Inventor: Jiangmei Wu, Bloomington, IN (US)

(73) Assignee: Indiana University Research and Technology Corporation, Indianapolis, IN (US)

(21) Appl. No.: 15/872,790

(22) Filed: Jan. 16, 2018

Related U.S. Application Data
(60) Provisional application No. 62/446,770, filed on Jan. 16, 2017.

(51) Int. Cl. F21V 1/18; F21V 1/26; F21V 1/14

(52) U.S. Cl. CPC F21V 1/18; F21V 1/143; F21V 1/26

(57) ABSTRACT

The present disclosure provides a method for producing light coverings that can take any arbitrary symmetrical volumetric forms and that can be flat-foldable or collapsible. The method can also be modified to produce other 3D structures that are collapsible by using other materials and assembly methods.

### CROSS-REFERENCE TO RELATED APPLICATIONS

This application claims the benefit under Title 35, U.S.C. § 119(e) of U.S. Provisional Patent Application Ser. No. 62/446,770, filed on Jan. 16, 2017, entitled Method For Producing Collapsible Structures, the disclosure of which is expressly incorporated herein in its entirety.

This application is related to U.S. Design patent application Ser. No. 29/591,061, filed on Jan. 16, 2017, entitled Light Covering.

### FIELD OF THE DISCLOSURE

The present disclosure relates generally to a method for producing a light covering. More particularly, the present disclosure relates to a method for producing a light covering that can be folded flat or is collapsible.

### BACKGROUND OF THE DISCLOSURE

Origami is generally based on folding techniques where a 2D object (e.g., a paper) is transformed into a 3D shape. However, by this methodology, it can be difficult to control aspects of the 3D shape (dimensions, etc.) that results from folding. As such, artists, mathematicians, and computer engineers, among others, are interested in reverse engineering the folding process involved by converting the 3D shape back to the 2D object in order to better control future 3D shapes formed from the 2D objects (e.g., paper).

### SUMMARY OF THE DISCLOSURE

The present disclosure provides a method for producing light coverings that can take any arbitrary symmetrical volumetric forms and that can be flat-foldable or collapsible. The method can also be modified to produce other 3D structures that are collapsible by using other materials and assembly methods.

According to one embodiment, the present disclosure provides a method for forming a collapsible structure. The method comprises: generating fold lines on a plurality of flat objects; folding the plurality of flat objects along the fold lines to form a plurality of modules including a first module, a second module and a third module; coupling a first edge of the first module to a first edge of the second module; coupling a second edge of the second module to a first edge of the third module; and coupling a second edge of the third module to a second edge of the first module.

According to another embodiment of the present disclosure, the method further comprises truncating a portion of the plurality of flat objects. According to another embodiment, the plurality of flat objects are formed of at least one of cotton paper, Tyvek sheet, polypropylene, or tear-free Shoji paper. According to another embodiment, the method further comprises coupling the collapsible structure to a support ring, crossbar, and a light source. According to another embodiment, the collapsible structure is configured to transition from an expanded configuration to a folded configuration by folding the collapsible structure along the fold lines when the collapsible structure is in the expanded configuration. According to another embodiment, each of the plurality of modules is substantially pyramidal. According to another embodiment, the collapsible structure is substantially symmetrical.

According to another embodiment, the present disclosure provides a collapsible structure. The collapsible structure comprises: a plurality of flat objects upon which fold lines are imprinted, whereby when the flat objects are folded along the fold lines, a plurality of modules are formed; wherein the fold lines are generated by a mathematical algorithm or computer program; wherein the fold lines form a symmetrical pattern on the plurality of flat objects and the plurality of modules; the plurality of modules are coupled to each other to form the collapsible structure; and the collapsible structure having an expanded configuration in which the coupled plurality of modules each have a first edge spaced apart from a second edge of the module and a folded configuration in which the coupled plurality of modules are folded along the fold lines and the first and second edges of each of the plurality of modules are adjacent to each other.

According to another embodiment, a portion of the plurality of flat objects are truncated to form the plurality of modules. According to another embodiment, the plurality of flat objects are formed of at least one of cotton paper, Tyvek sheet, polypropylene, or tear-free Shoji paper.

According to yet another embodiment, the present disclosure provides a method of forming a collapsible structure. The method of forming a collapsible structure comprises: generating fold lines on a plurality of flat objects; truncating a portion of the plurality of flat objects; folding the plurality of flat objects along the fold lines to form a plurality of modules including at least a first module, a second module and a third module; forming a first row of modules including the first module coupled to the second module and the second module coupled to the third module; wherein the first module has a first end coupled to a first end of the second module, and the second module has a second end coupled to a first end of the third module; forming a second row of modules including a fourth module coupled to a fifth module and the fifth module coupled to a sixth module; wherein the fourth module has a first end coupled to a first end of the fifth module, and the fifth module has a second end coupled to a first end of the sixth module; forming a third row of modules including a seventh module coupled to an eighth module and the eighth module coupled to a ninth module; wherein the seventh module has a first end coupled to a first end of the eighth module, and the eighth module has a second end coupled to a first end of the ninth module; coupling a first edge of the first row of modules to a first edge of the second row of modules; coupling a second edge of the second row of modules to a first edge of the third row of modules; and coupling a second edge of the third row of modules to a second edge of the first row of modules.

According to another embodiment, each of the modules is symmetrical. According to another embodiment, the first row of modules, the second row of modules, and the third row of modules are configured to be offset from each other. According to another embodiment, the plurality of flat objects are formed of at least one of cotton paper, Tyvek sheet, polypropylene, or tear-free Shoji paper. According to another embodiment, the collapsible structure further includes: an expanded configuration in which each of the coupled plurality of modules has a first edge spaced apart from a second edge of the module and a folded configuration in which the coupled plurality of modules are folded along the fold lines and the first and second edges of the plurality of modules are adjacent to each other. According to another embodiment, wherein each of the plurality of modules is substantially pyramidal. According to another embodiment, the method further includes coupling the collapsible structure to a support ring, a crossbar, and a light source.

### BRIEF DESCRIPTION OF THE DRAWINGS

The features of this disclosure, and the manner of attaining them, will become more apparent and the disclosure itself will be better understood by reference to the following description of embodiments of the disclosure taken in conjunction with the accompanying drawings.

FIG. 1 is a perspective view of a module for a collapsible light covering;

FIG. 2 is a top view of the module of FIG. 1;

FIG. 3 is a perspective view of the rows of the module of FIG. 1 in various dimensions;

FIG. 4 is a back, perspective view of the pattern of FIG. 3;

FIG. 5A is a plan view of an alternate unrolled module to be folded to form a module

FIG. 5B is a plan view of an alternate unrolled module to be folded to form a module;

FIG. 6 is a perspective view of a light covering apparatus having a light covering constructed of the modules of FIG. 1;

FIG. 7 is a front view of the light covering apparatus of FIG. 6;

FIG. 8A is a top view of the light covering apparatus of FIG. 6;

FIG. 8B is a bottom view of the light covering apparatus of FIG. 6;

FIGS. 9-20 are perspective views of alternate embodiments of the light covering shown in FIG. 6;

FIG. 21 is a perspective view of a light covering that is in a collapsed or folded configuration;

FIG. 22 is a perspective view of a light source and a support structure for the light covering according to an embodiment of the present disclosure; and

FIG. 23 is a perspective view of a support ring engaging with a light covering according to an embodiment of the present disclosure.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplifications set out herein illustrate an exemplary embodiment of the disclosure, in one form, and such exemplifications are not to be construed as limiting the scope of the disclosure in any manner.

### DETAILED DESCRIPTION OF THE DRAWINGS

The embodiments disclosed herein are not intended to be exhaustive or limit the disclosure to the precise form disclosed in the following detailed description. Rather, the embodiments are chosen and described so that others skilled in the art may utilize their teachings.

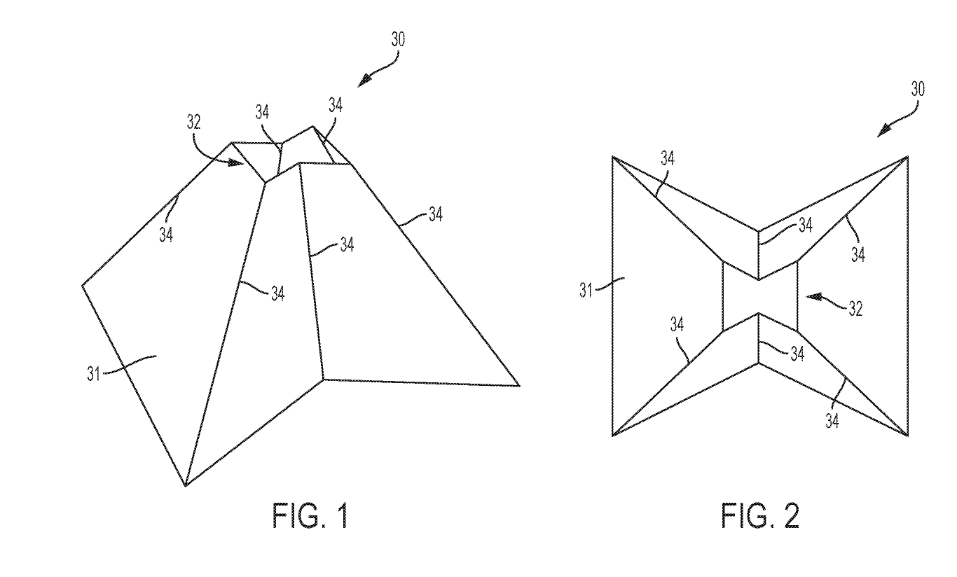

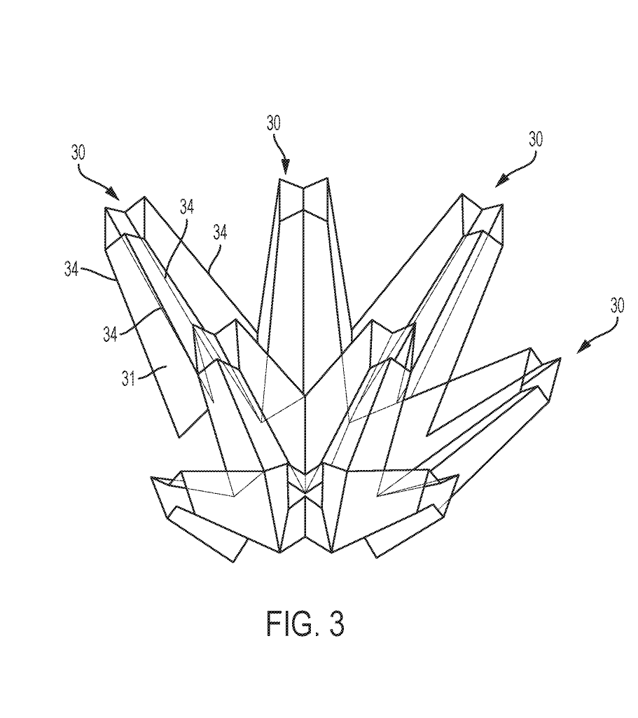

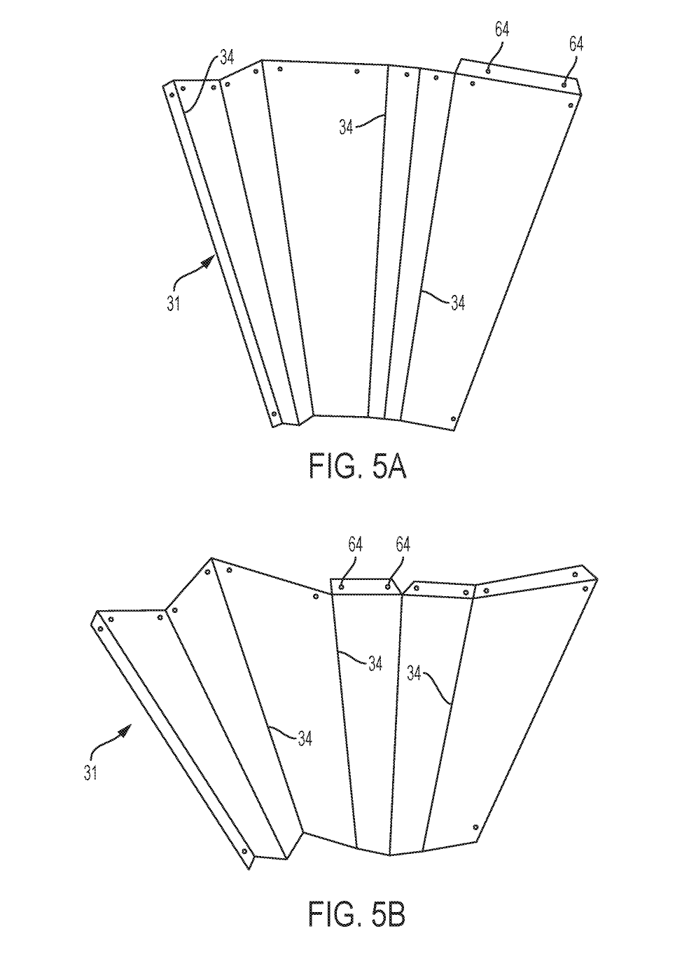

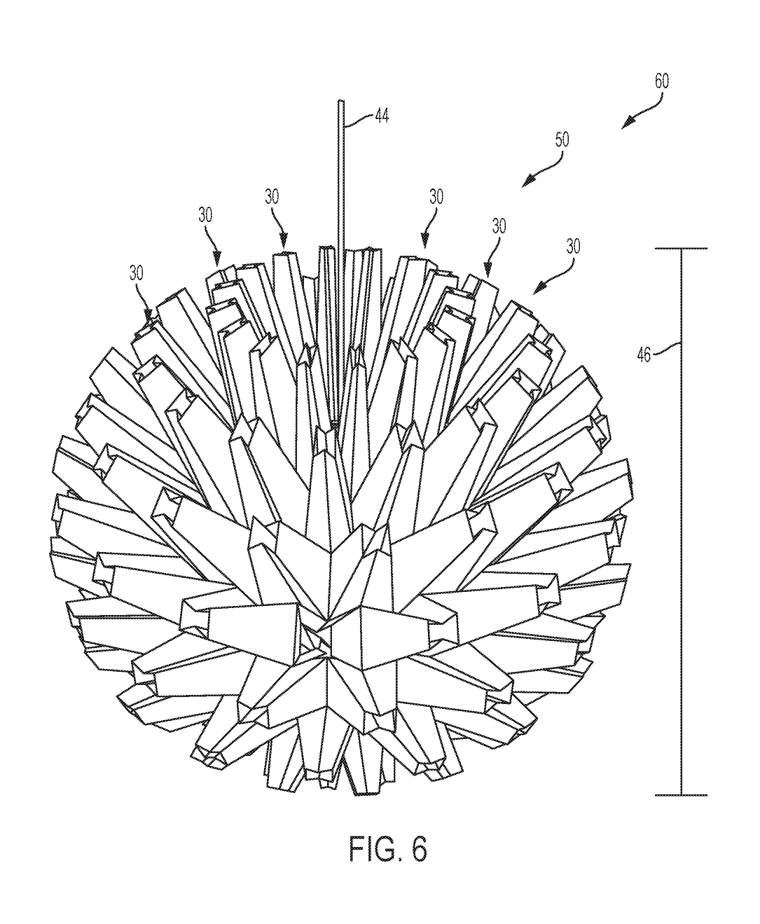

Referring first to FIGS. 1 and 2, a module 30 is shown. Module 30 includes a truncated portion 32 and fold lines 34. Module 30 begins as a two-dimensional shape (FIG. 5A or FIG. 5B) of material 31 (e.g., paper, origami paper, etc.) having a series of fold lines 34 imprinted on material 31. When folded, the two-dimensional shape (FIG. 5A or FIG. 5B, for example), becomes a module 30 for use with other modules 30 in a light covering apparatus as discussed in greater detail below. In some embodiments, module 30 is made of paper, such as cotton paper, and in other embodiments, module 30 is made of a synthetic material able to be scored and folded, such as Tyvek sheet by DuPont. In alternate embodiments, other types of paper or plastic sheets may be used, such as polypropylene, or high-density polyethylene. In one embodiment, the material used is a type of tear-free Shoji paper called Hi-tec Kozo, which has a three layer structure with an eco-friendly polyester film as its core and a renewable material that is made from the inner bark of the mulberry tree, known as Kozo Washi positioned on both sides.

Module 30 begins as a two-dimensional sheet of material 31 as shown in FIGS. 5A, 5B. By use of a mathematical algorithm and/or computer programs, various fold lines or score lines 34, also referred to as crease lines are obtained. In some embodiments, fold lines 34 are indentations made in material 31 of module 30 by a hand tool or by an automated device, such as a digital cutter or a laser cutter. In other embodiments, fold lines 34 are partial cuts in the material for module 30. Still in other embodiments, fold lines 34 are a printed pattern made by ink or a substantially similar substance, such as graphite.

As shown throughout in FIGS. 1-5B, fold lines 34 lie in different directions. In an alternate embodiment, some fold lines 34 are substantially parallel with each other. In the illustrated embodiment of FIGS. 3-5A, fold lines 34 are oriented on material 31 such that module 30 (which is formed when material 31 is folded along fold lines 34) forms a substantially triangular or pyramidal shape (e.g., FIG. 3). However, it is contemplated that in alternate embodiments, fold lines 34 may be reconfigured on the material of module 30 to form an alternate shape when folded. That is, any configuration for fold lines 34 is envisioned as long as fold lines 34 can be folded in a series of mountain and valley folds (described further below) into a three-dimensional structure. In one embodiment, the orientation of fold lines 34 provides module 30 with a substantially symmetrical orientation when material 31 is folded. A portion of module 30 can be cut to form a module 30 with truncated portion 32 (as shown in FIGS. 2, 3, 4, and 5A) when material 31 is folded along fold lines 34. However, it is within the scope of the present disclosure that modules 30 can be cut after material 31 is folded along fold lines 34 or after individual modules 30 are coupled to each other to forms rows.

In one embodiment, each module 30 is constructed from material 31 (e.g., FIG. 5A, 5B) such that each module 30 is substantially identical to each other. However, it is within the scope of the present disclosure that in alternate embodiments, material 31 used for one module may be of one shape before it is folded (e.g., square, rectangle) and material 31 for another module may be of another shape that is different from the previous module (e.g., square, rectangle). That is, a module 30 formed from one material 31 may be different from another module 30 formed from another material 31.

As mentioned previously, when material 31 is folded along fold lines 34, module 30 is formed. Similar to the imprinting techniques previously discussed, folding material 31 along fold lines 34 can be done by a hand tool or an automated device, such as a laser cutter.

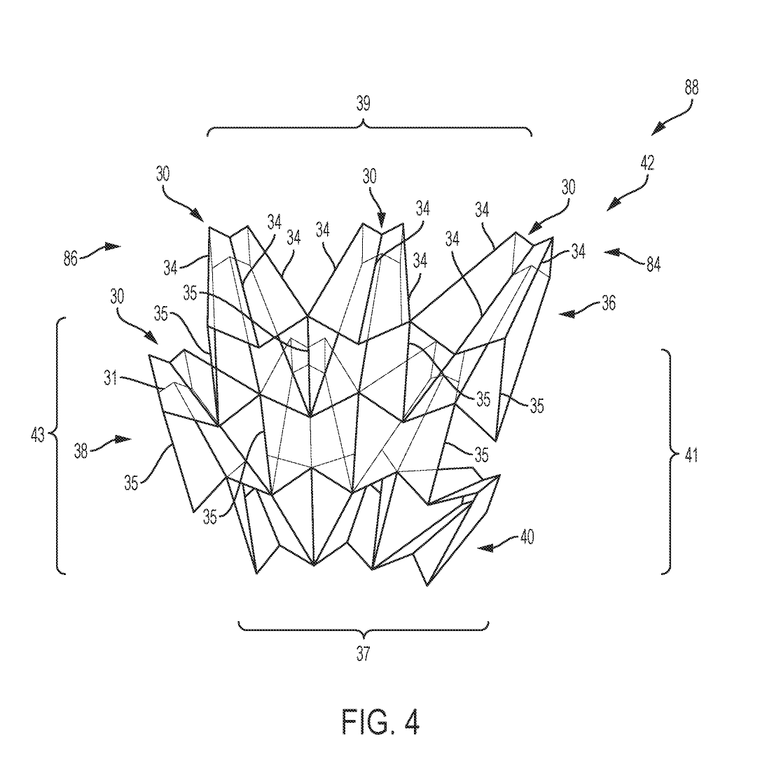

As shown in FIGS. 3 and 4, modules 30 can be coupled to each other to form rows of modules 36, 38, and 40 (FIG. 4). Rows 36, 38, and 40 can then be coupled to each other to form a sheet 42 of offsetting modules 30. However, it is contemplated that in alternate embodiments, each module 30 can be individually coupled to each other to form the configuration shown in FIGS. 3 and 4. It is also contemplated that modules 30 can be coupled to form alternate configurations.

To form rows 36, 38, and 40, modules 30 are coupled to one another along the entirety of edge 35 of each module 30 such that fold lines 34 of one module 30 correspond to fold lines 34 of another module 30 as shown in FIGS. 3-5A. Modules 30 of row 36 have different patterns (from fold lines 34) than modules 30 of rows 38, 40. Likewise, modules 30 of row 38 have different patterns (from fold lines 34) than modules 30 of rows 36 and 40. Furthermore, modules 30 of row 40 have different patterns than modules 30 of rows 36 and 38. However, it is within the scope of the present disclosure that rows of modules can have the same pattern (from fold lines 34) as other rows of modules.

When coupling row 36 to row 38 and row 38 to row 40 to form configuration 88 as shown in FIGS. 3-5A, rows 36, 38, and 40 are positioned in a staggered (or offset) configuration in which one of the exposed edges 35 of a module 30 of one row are coupled to a portion of an exposed edge 35 of at least one other module 30 of another row. For example, a module 30 of row 36 has an edge 35 that is coupled to a portion of edge 35 of a module 30 of row 38 and another portion of edge 35 of an adjacent module 30 of row 38 as shown in FIGS. 3-5A. As mentioned earlier, each module 30 has a symmetrical orientation due to the pattern of fold lines 34 on material 31. The symmetrical orientation provides for forming a collapsible sheet 42 where sheet 42 may be collapsed or expanded along fold lines 34 as discussed further herein.

Once the requisite number of rows of modules are formed and coupled to each other, the first and last rows of modules 30 are coupled to each other such that exposed edges 37, 39 (formed by exposed edges 35 of modules 30) of the first row and the final row are coupled. Exposed edges 41 and 43 (formed by exposed edges 35 of modules 30) are also coupled to each other to form a light covering (e.g., light covering 50 as discussed further herein). For example, exposed edges 39 and 37 of rows 36 and 40, respectively, are coupled to each other and exposed edges 43 and 45 are coupled to each other to form a light covering 50. In this way, a sheet 42 with a greater number of modules 30 and rows 36, 38, and 40 is converted into a light covering 50 as shown in FIG. 6.

Light covering 50 comprises a plurality of modules 30 that are coupled to one another to form a distinct shape. Light covering 50 can then be coupled with additional structural components when in use as discussed in greater detail below.

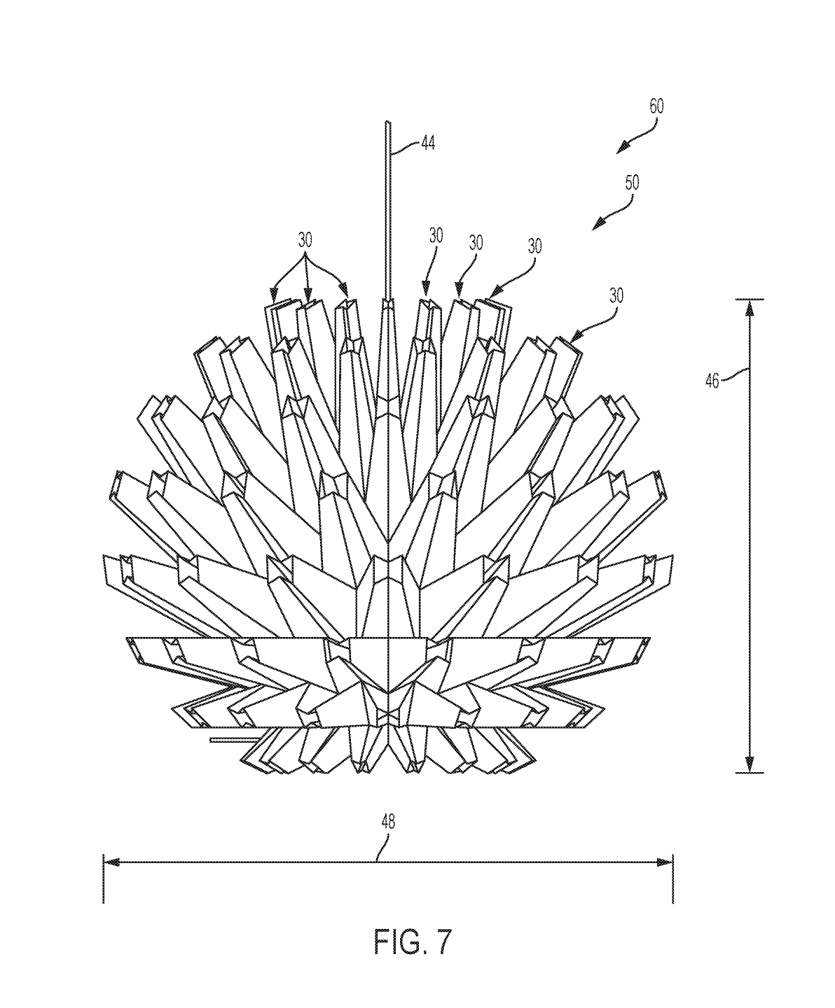

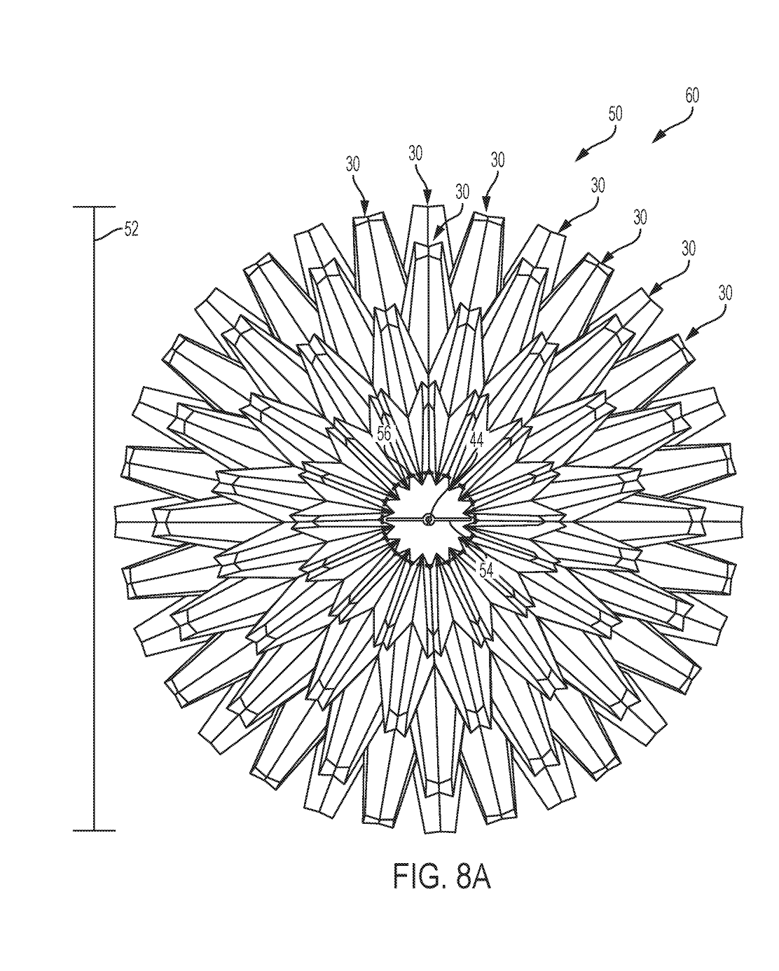

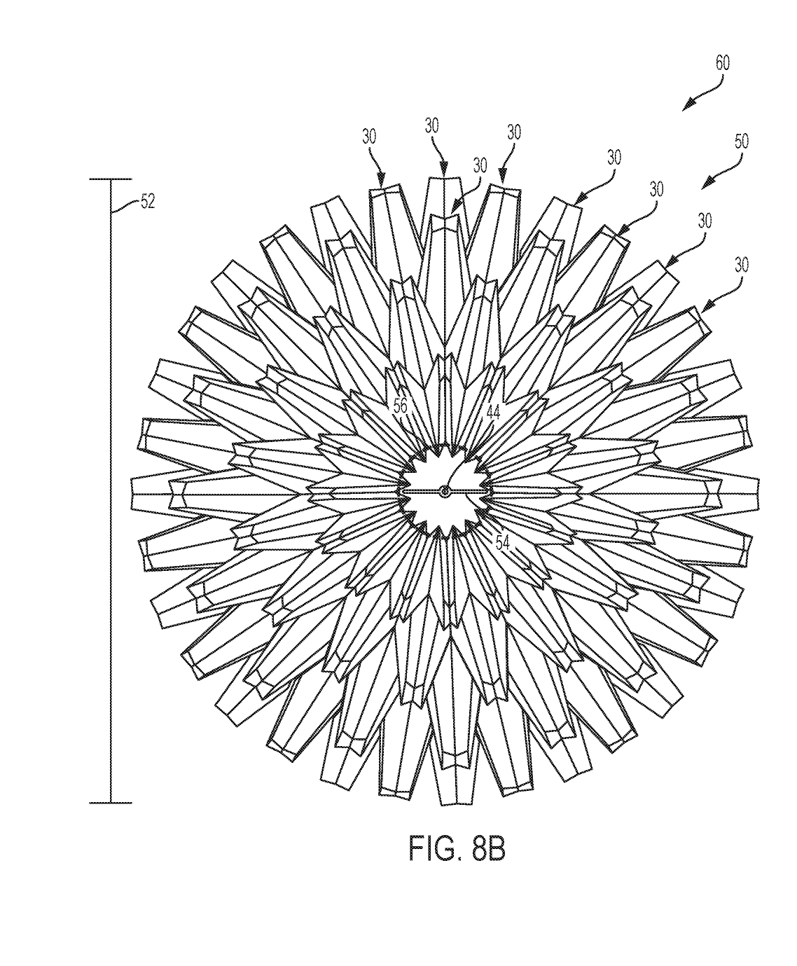

As shown in FIGS. 7, 8A, and 8B, light covering 50 has a height 46, a width 48, and a depth 52. In one embodiment, height 46 may be between 18 inches to 36 inches, 20 inches to 30 inches, or 25 inches to 28 inches, or within any range defined by any two of the foregoing values. Width 48 may be between 18 inches to 36 inches, 20 inches to 30 inches, or 25 inches to 28 inches, or within any range defined between any two of the foregoing values. Depth 52 may be between 18 inches to 36 inches, 20 inches to 30 inches, or 25 inches to 28 inches, or within any range defined by any two of the foregoing values. Other suitable height 46, width 48 and depth 52 dimensions may be used in other embodiments.

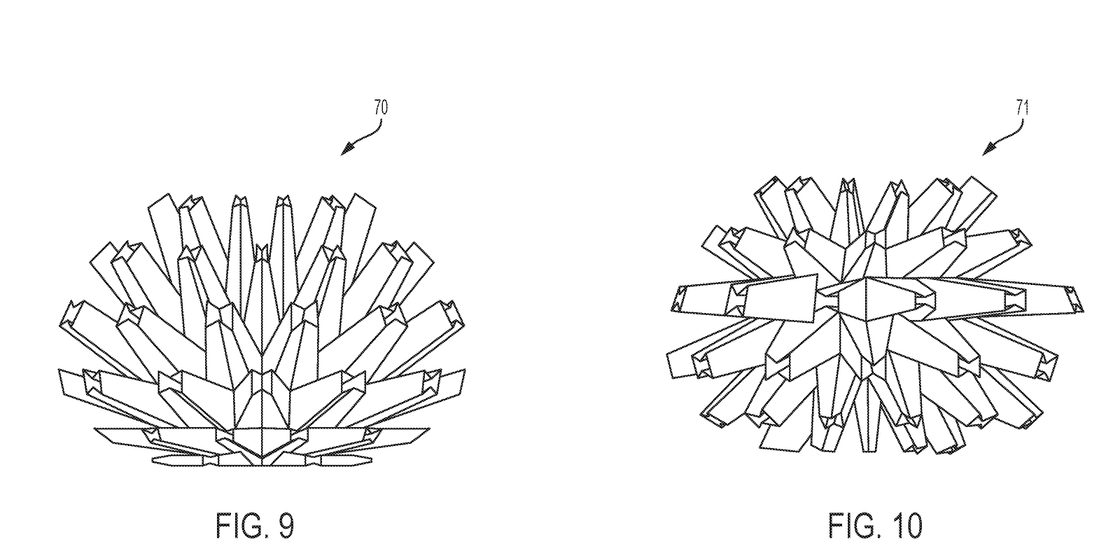

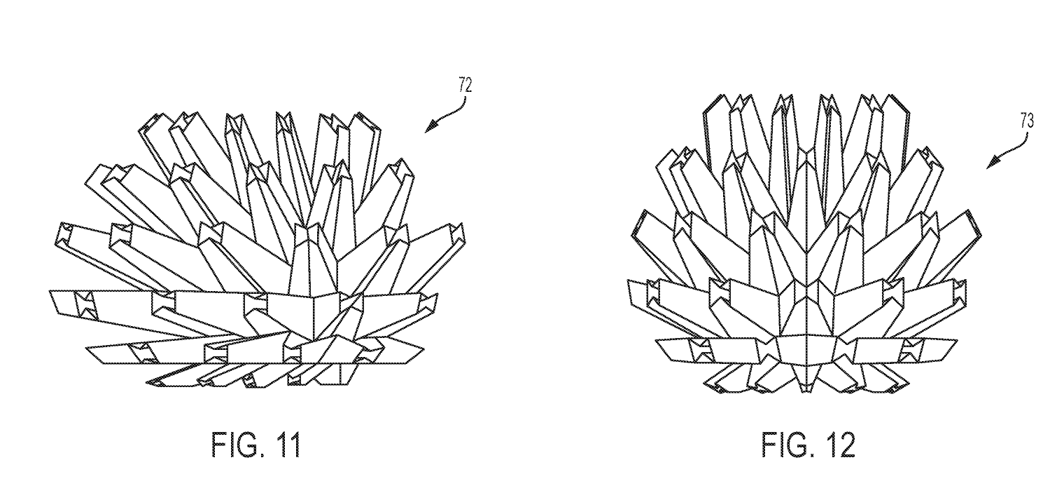

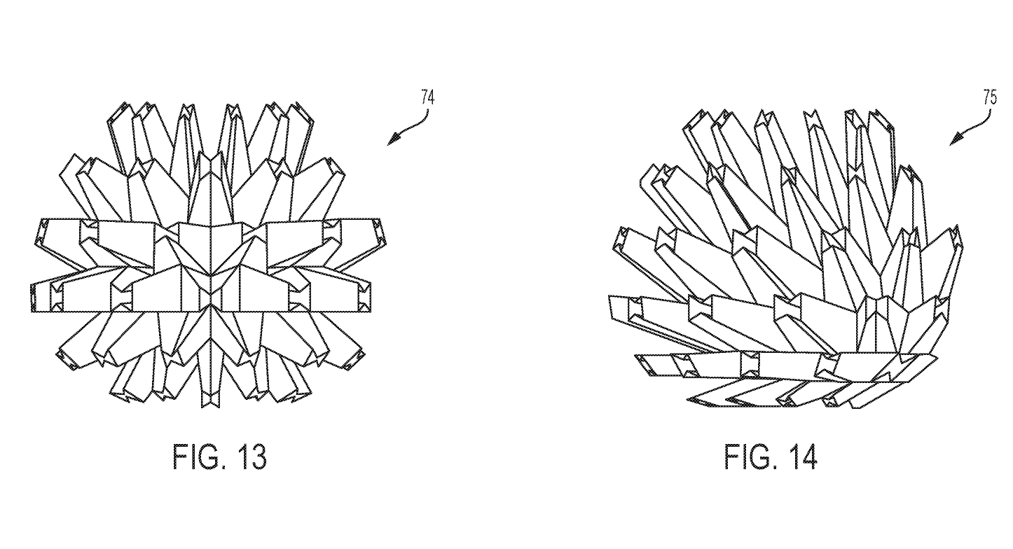

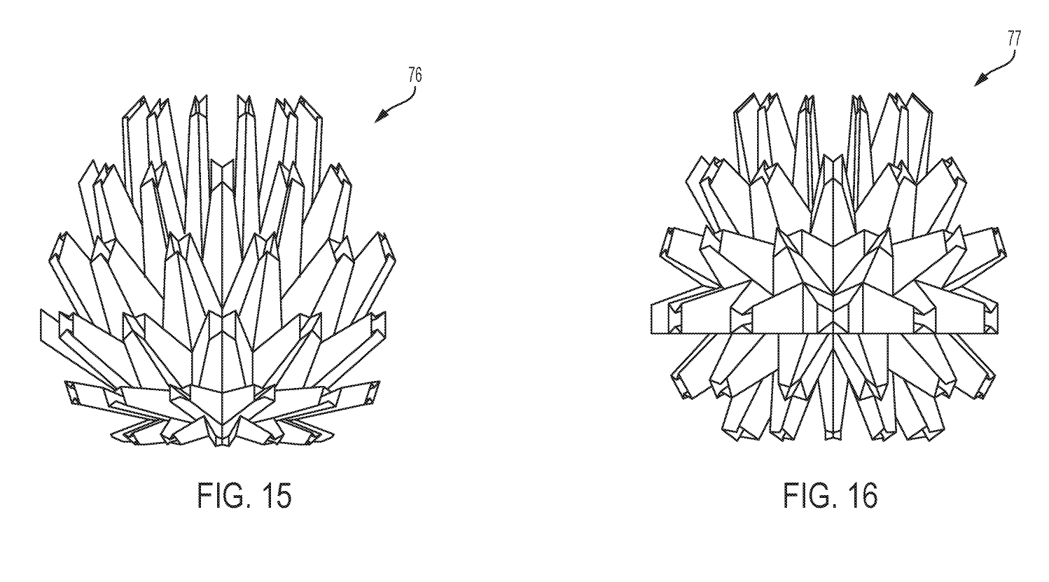

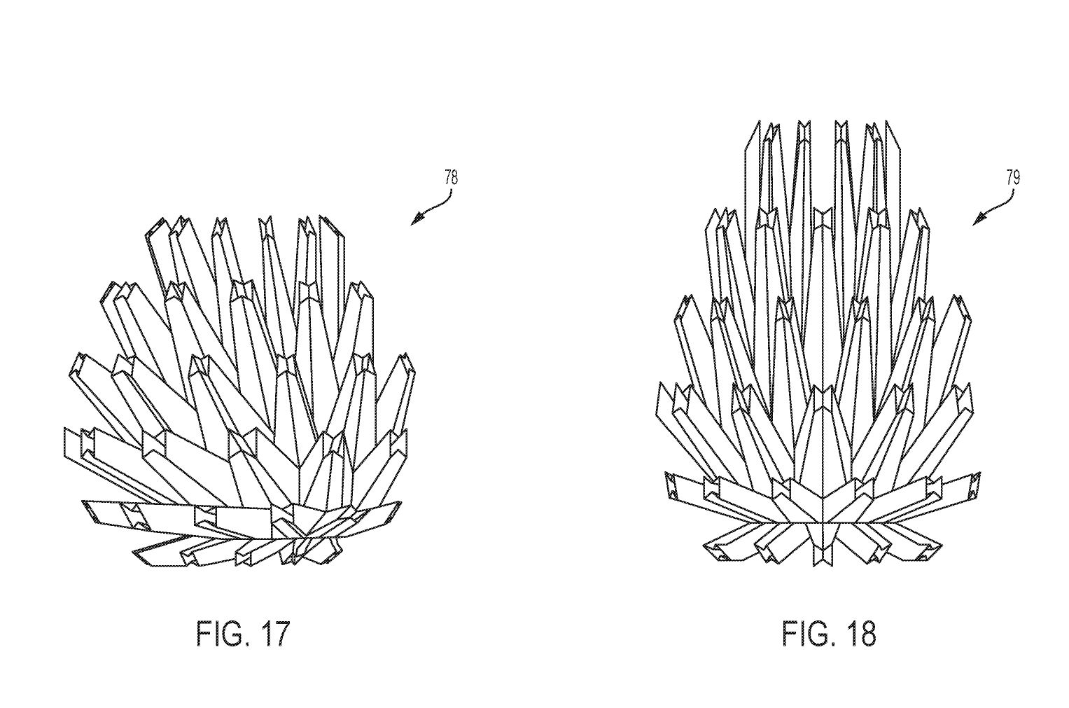

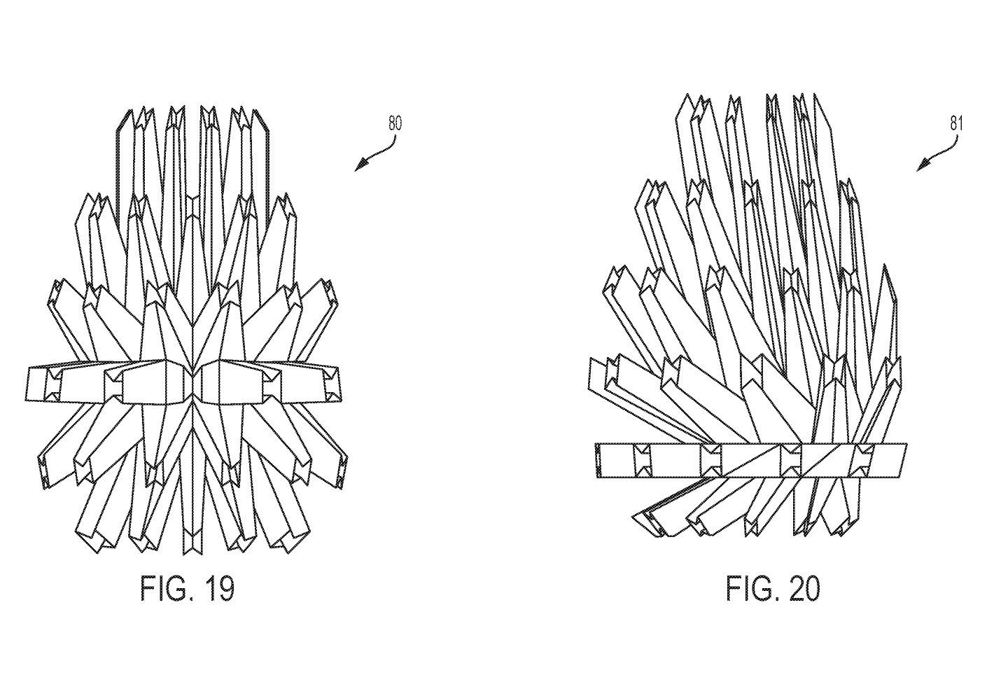

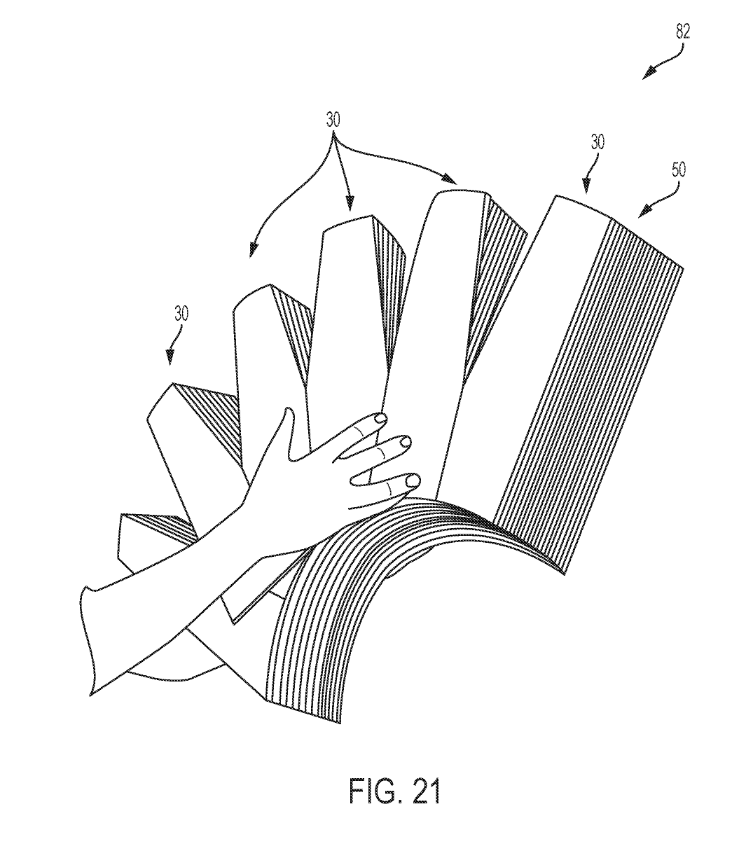

FIGS. 9-20 show alternate light coverings 70-81 of light covering 50. Light coverings 70-81 are formed by coupling modules 30 to each other as previously discussed. However, the number of modules 30 used as well as the location at which the modules are coupled to each other serve to create alternate light coverings 70-81. Alternate light coverings 70-81 are also collapsible and like light covering 50, alternate light coverings 70-81 can form a similar collapsed configuration 82 generally shown in FIG. 21 and discussed below.

Light covering 50, as shown in FIGS. 6-8B, is also foldable or compressible to aid in compact storage. To store light covering 50, edges 41 and 43 are decoupled from each other, and edges 37, 39 of the first and last row that were coupled to form light covering 50 are detached from one another to re-form sheet 42. Once sheet 42 is re-formed, rows 36, 38, and 40 are separated along the shared edges by which the rows are coupled. That is, rows 36, 38, and 40 are decoupled from each other such that rows 36, 38, and 40 are separate from each other. Once rows 36, 38, 40 are separated, axial forces are applied onto rows 36, 38, and 40 in the directions indicated by arrows 84 and 86 (FIG. 4) to compress rows 36, 38, and 40 of sheet 42 along edges 35 and fold lines 34. The folded rows of rows 36, 38, and 40 are stacked on each other thereby transitioning sheet 42 from an expanded configuration 88 as shown in FIG. 4 to a folded or collapsed configuration 82 as shown in FIG. 21.

The ability of light covering 50 to be foldable, i.e., to transition from the expanded configuration 88 (FIG. 4) to the folded configuration 82 allows for flexible, compact storage. Once in the folded configuration 82, light covering 50 can be stored within a container more efficiently as light covering 50 occupies less space within the container. This also provides for easier transportation of light covering 50 and other light covering embodiments disclosed herein.

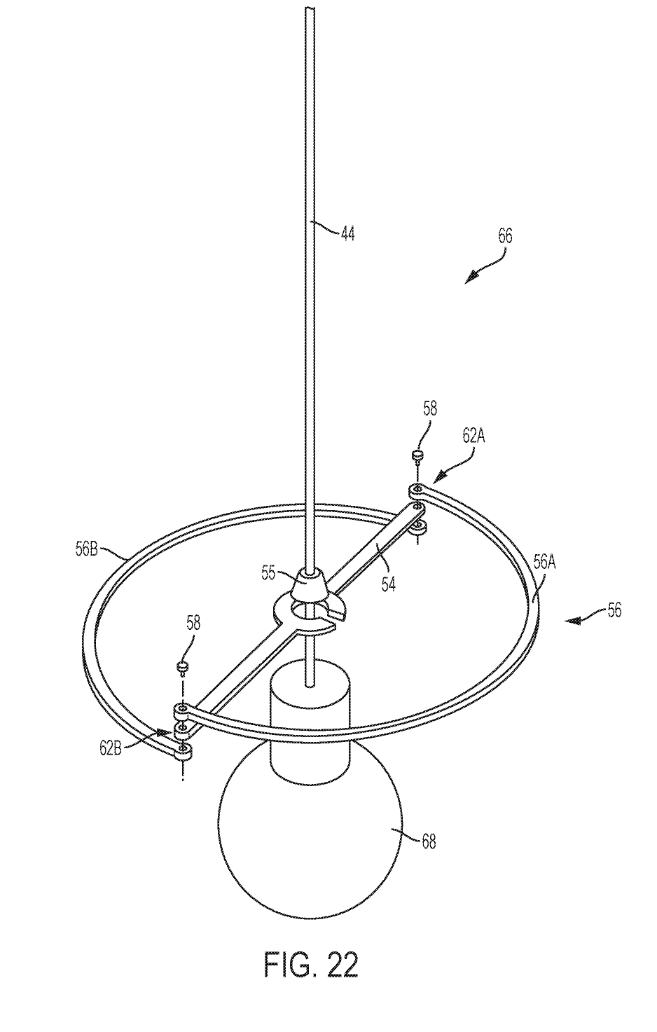

As shown in FIG. 7, light covering 50 is coupled to a rod 44 to form light covering apparatus 60. Referring now to FIG. 22, structural components 66 for light covering apparatus 60 (FIG. 6) are shown. Structural components 66 include rod 44, a cap 55, a support ring 56, a crossbar 54, and a light source 68. Rod 44 is coupled to light source 68 and is generally attached to a surface from which light source 68 is hung. Rod 44 is coaxial with cap 55 and is coupled to support ring 56 by crossbar 54. Cap 55 is configured to assist in holding crossbar 54 in place adjacent to light source 68, i.e. preventing excess rotational or axial movement of crossbar 54. Light source 68 is a light bulb in the illustrated embodiment. However, it is contemplated that in alternate embodiments, other suitable light sources may be used, e.g., LED light bulbs, etc.

Crossbar 54 is coupled to support ring 56 at connecting joints 62A, 62B. As shown in FIG. 22, support ring 56 includes support ring halves 56A, 56B, which are coupled to one another and to crossbar 54 at each of their respective ends by screws 58 as discussed further below. In the embodiment shown in FIG. 22, crossbar 54 and ends of support ring halves 56A and 56B each have a hole of a certain size. The holes of these structures are aligned with one another at connecting joints 62A, 62B such that screws 58 can be inserted within the holes to thereby couple support ring half 56A, crossbar 54, and support ring half 56B. It is contemplated that in alternate embodiments, other coupling means may be used such as fasteners, pins, clips, nuts and bolts, etc.

In one embodiment, support ring 56 and crossbar 54 are made of stainless steel and cap 55 is made of plastic. However, it is contemplated that in alternate embodiments, other suitable materials may be used for the apparatus.

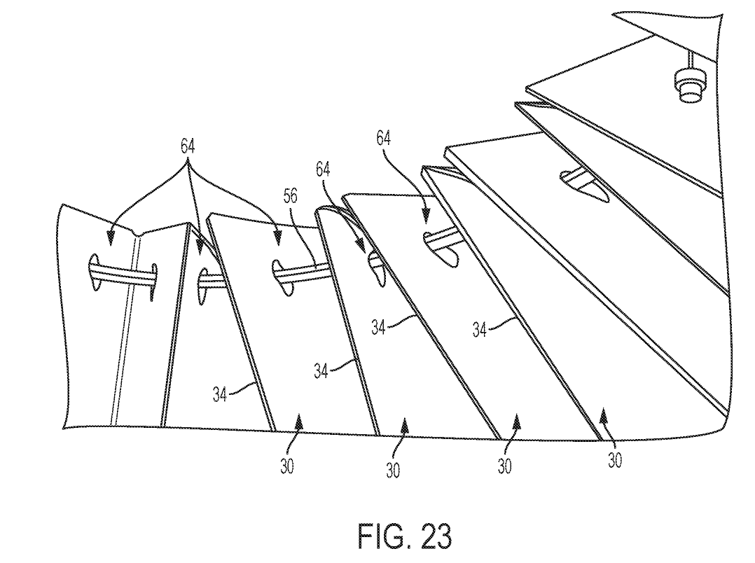

Referring now to FIG. 23, an exemplary light covering is shown. The exemplary light covering shown includes at least one hole 64 within the exemplary light covering. Holes 64 are formed into the light covering once the exposed edges of the rows of modules are coupled to one another. However, it is contemplated that holes 64 can be formed during other stages of assembly of the exemplary light covering, such as, for example, after the assembly of a row of modules. Holes 64 are configured to receive support ring 56 to support light covering 50 when light covering apparatus 60 is assembled. That is, support ring 56 is fed through series of holes 64 within modules 30 of exemplary light covering 50 when constructing light covering apparatus 60. In one embodiment, support ring halves 56A and 56B are each fed through holes 64 of the exemplary light covering. Once support ring halves 56A, 56B are fed through the holes 64, support ring halves 56A and 56B are coupled to each other and crossbar 54 as previously discussed. In this way, light covering apparatus 60 is constructed such that an exemplary light covering is supported by structural components 66, while also covering light source 68.

Disassembly of light covering apparatus 60 involves decoupling of support ring halves 56A, 56B and crossbar 54 by removing screws 58. Once screws 58 are removed, support ring halves 56A, 56B can be decoupled from each other and from crossbar 54. Support ring halves 56A and 56B can then be removed from holes 64 of light covering 50, 70-81. In this way, any one of light coverings 50, 70-81 can be decoupled from support ring 56 and can then be disassembled such that light coverings 50, 70-81 can transition from expanded configuration 88 (FIG. 4) to folded configuration 82 as previously discussed.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within the known or customary practice in the art to which this disclosure pertains.

What is claimed is:

1. A method for forming a collapsible structure, comprising:
generating fold lines on a plurality of flat objects;
folding the plurality of flat objects along the fold lines to form a plurality of modules including a first module, a second module and a third module;
coupling a first edge of the first module to a first edge of the second module;
coupling a second edge of the second module to a first edge of the third module; and
coupling a second edge of the third module to a second edge of the first module.

2. The method of claim 1, further comprising truncating a portion of the plurality of flat objects.

3. The method of claim 1, wherein the plurality of flat objects are formed of at least one of cotton paper, Tyvek sheet, polypropylene, or tear-free Shoji paper.

4. The method of claim 1, further comprising coupling the collapsible structure to a support ring, crossbar, and a light source.

5. The method of claim 1, wherein the collapsible structure is configured to transition from an expanded configuration to a folded configuration by folding the collapsible structure along the fold lines when the collapsible structure is in the expanded configuration.

6. The method of claim 1, wherein each of the plurality of modules is substantially pyramidal.

7. The method of claim 1, wherein the collapsible structure is substantially symmetrical.

8. A collapsible structure comprising:
a plurality of flat objects upon which fold lines are imprinted, whereby when the flat objects are folded along the fold lines, a plurality of modules are formed;
wherein the fold lines are generated by a mathematical algorithm or computer program;
wherein the fold lines form a symmetrical pattern on the plurality of flat objects and the plurality of modules;
the plurality of modules are coupled to each other to form the collapsible structure; and
the collapsible structure having an expanded configuration in which the coupled plurality of modules each have a first edge spaced apart from a second edge of the module and a folded configuration in which the coupled plurality of modules are folded along the fold lines and the first and second edges of each of the plurality of modules are adjacent to each other.

9. The collapsible structure of claim 8, wherein a portion of the plurality of flat objects are truncated to form the plurality of modules.

10. The collapsible structure of claim 8, wherein the plurality of flat objects are formed of at least one of cotton paper, Tyvek sheet, polypropylene, or tear-free Shoji paper.

11. A method of forming a collapsible structure comprising:
generating fold lines on a plurality of flat objects;
truncating a portion of the plurality of flat objects;
folding the plurality of flat objects along the fold lines to form a plurality of modules including at least a first module, a second module and a third module;
forming a first row of modules including the first module coupled to the second module and the second module coupled to the third module;
wherein the first module has a first end coupled to a first end of the second module, and the second module has a second end coupled to a first end of the third module;
forming a second row of modules including a fourth module coupled to a fifth module and the fifth module coupled to a sixth module;
wherein the fourth module has a first end coupled to a first end of the fifth module, and the fifth module has a second end coupled to a first end of the sixth module;
forming a third row of modules including a seventh module coupled to an eighth module and the eighth module coupled to a ninth module;
wherein the seventh module has a first end coupled to a first end of the eighth module, and the eighth module has a second end coupled to a first end of the ninth module;
coupling a first edge of the first row of modules to a first edge of the second row of modules;
coupling a second edge of the second row of modules to a first edge of the third row of modules; and
coupling a second edge of the third row of modules to a second edge of the first row of modules.

12. The method of claim 11, wherein each of the modules is symmetrical.

13. The method of claim 11, wherein the first row of modules, the second row of modules, and the third row of modules are configured to be offset from each other.

14. The method of claim 11, wherein the plurality of flat objects are formed of at least one of cotton paper, Tyvek sheet, polypropylene, or tear-free Shoji paper.

15. The method of claim 11, wherein the collapsible structure further includes: an expanded configuration in which each of the coupled plurality of modules has a first edge spaced apart from a second edge of the module and a folded configuration in which the coupled plurality of modules are folded along the fold lines and the first and second edges of the plurality of modules are adjacent to each other.

16. The method of claim 11, wherein each of the plurality of modules is substantially pyramidal.

17. The method of claim 11, further including coupling the collapsible structure to a support ring, a crossbar, and a light source.
